(19) United States
(12) Patent Application Publication
(10) Pub. No.: US 2014/0075553 A1
(43) Pub. Date: Mar. 13, 2014

(54) DOMAIN NAME SYSTEM REBINDING ATTACK PROTECTION

(71) Applicant: Robert Hansen, Austin, TX (US)

(72) Inventor: Robert Hansen, Austin, TX (US)

(21) Appl. No.: 13/610,806

(22) Filed: Sep. 11, 2012

(51) Int. Cl. G06F 21/00

(52) U.S. Cl. 726/22

(57) ABSTRACT

A network-enabled electronic system is arranged to determine whether a subsequent DNS request uses a selected domain name of a previous DNS request. A protective action is taken in response to an indication that the subsequent DNS request uses the selected domain name of a previous DNS request. The protective action can include flushing state information that could be used to generate a request using an address that is (maliciously, for example) rebound to the selected domain name.

### BACKGROUND

Network-enabled applications are applications that use communication networks to share information between various devices, each of which might be operated by the same or different user. The network-enabled applications include applications such as browser engines, messaging interfaces, e-mail tools, remote desktops, and the like that allow users to easily browse, select, and manipulate items being viewed using a network-enabled application. The network-enabled application receives one or more communications (such as code for instantiating webpages) from a service provider that is often encoded in the form of a language (such as the hypertext markup language HTML), which contains elements that describe the structure and functionality of the content that is received by the content user.

The communication networks over which the network-enabled applications communicate are often arranged as a private network having an internal address space. The private network is typically addressed using Internet protocol (IP) addresses in accordance with an Internet protocol such as (request for comments-) RFC-1918. The IP addresses of the private network are often not globally allocated and thus are not intended to be transmitted across the public Internet. The private network is typically shielded from the public Internet by a firewall and thus communicates with various devices across the public Internet by using network address translation and/or a proxy server.

However, various devices having IP addresses in the private network that do not allow external accesses are subject to hacking when an attacker uses a domain name system (DNS) rebinding attack. The DNS rebinding attack can attempt to use a device in the private network that has access to the Internet to send a command to a (relatively) non-externally accessible device on the behalf of the attacker. A browser (which is internal) of the device in the private network that has access to the Internet can be used to send, for example, information obtained from the executed command back to a site controlled by the attacker.

In a typical DNS rebinding attack, an attacker attempts to rebind a DNS binding on a victim machine from a binding between a domain name and an IP address (controlled by the attacker) to a binding between the domain name and an IP address that is controlled by the victim. The IP address controlled by the victim is often an IP address of a network computing resource that lies within a relatively secure zone of the victim. The rebinding is used by the attacker to, for example, access the network computing resource (that would otherwise be inaccessible to the attacker) using the rebound IP address.

### BRIEF DESCRIPTION OF THE DRAWINGS

FIG. 1 is a network diagram illustrating a network that is suitable for practicing aspects of dynamic name system rebinding attack protection in accordance with exemplary embodiments of the disclosure;

FIG. 2 shows an illustrative computing device in accordance with exemplary embodiments of the disclosure;

FIG. 3 is a network diagram illustrating in conjunction with FIG. 2 a network that includes domain name system rebinding attack protection in accordance with exemplary embodiments of the disclosure;

FIG. 4 is a logic diagram illustrating a network resource having a domain name service rebinding protector in accordance with exemplary embodiments of the disclosure;

FIG. 5 is a signaling diagram illustrating in conjunction with FIG. 4 operation of a domain name service rebinding protection architecture in accordance with exemplary embodiments of the disclosure; and

FIG. 6 is a flow diagram illustrating domain name service rebinding protection architecture in accordance with exemplary embodiments of the disclosure.

### DETAILED DESCRIPTION

The following discussion is directed to various exemplary embodiments of the disclosure. Although one or more of these exemplary embodiments may be preferred, the exemplary embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description—and claims—to refer to particular system components. As one skilled in the art will appreciate, various names may be used to refer to a component. Accordingly, distinctions are not necessarily made herein between components that differ in name but not function. In the following discussion and in the claims, the terms “including” and “comprising” are used in an open-ended fashion, and thus are to be interpreted to mean “including, but not limited to . . . .” Also, the terms “coupled to” or “couples with” (and the like) are intended to describe either an indirect or direct electrical, optical and/or wireless connection. Thus, if a first device couples to a second device, that connection can be made through a direct connection, or through an indirect connection via other devices and connections.

The term “domain” as used herein refers to either a domain or a portion of the domain (“subdomain”) if any. Thus, the term “subdomain” can be used to refer to a portion of the “domain.” A subdomain can be, for example, a domain name server (DNS) record. For example, the name “www.example.com” can be used in a localized context to refer to a domain (notwithstanding the fact that “www.example.com” is itself a subdomain of “example.com”). While net-enabled applications such as browsers follow a “same origin” policy and tend to use the longer version “www.example.com” as an origin domain name, the net-enabled applications also use the shorter version “example.com” for certain purposes (such as for cookies that are set with the domain switch). Thus all subdomains of the domain “example.com” include “no-subdomains” (such as “http://example.com/” and “http://whatever.example.com/”) and include the more-specific subdomains (such as www.example.com). The term “render” can be used to describe a change rendered in the logical structure of a Document Object Model (DOM) as well as a graphical rendering of the DOM element. The term “portion” means an entire portion or a portion that is less than the entire portion.

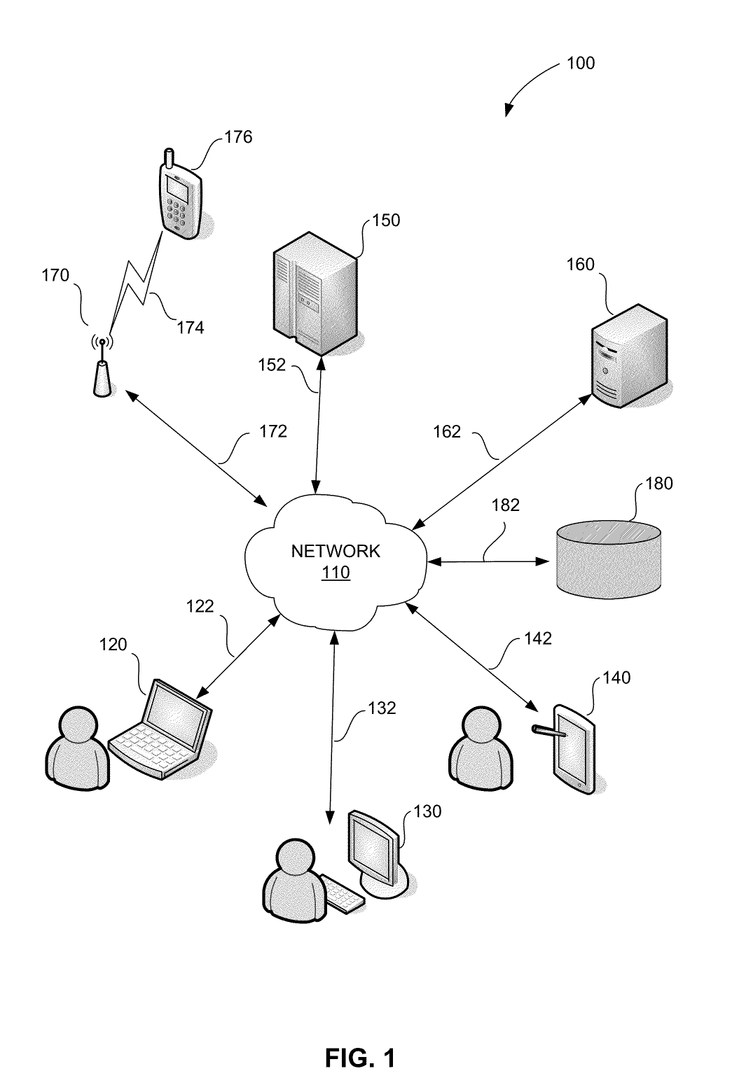

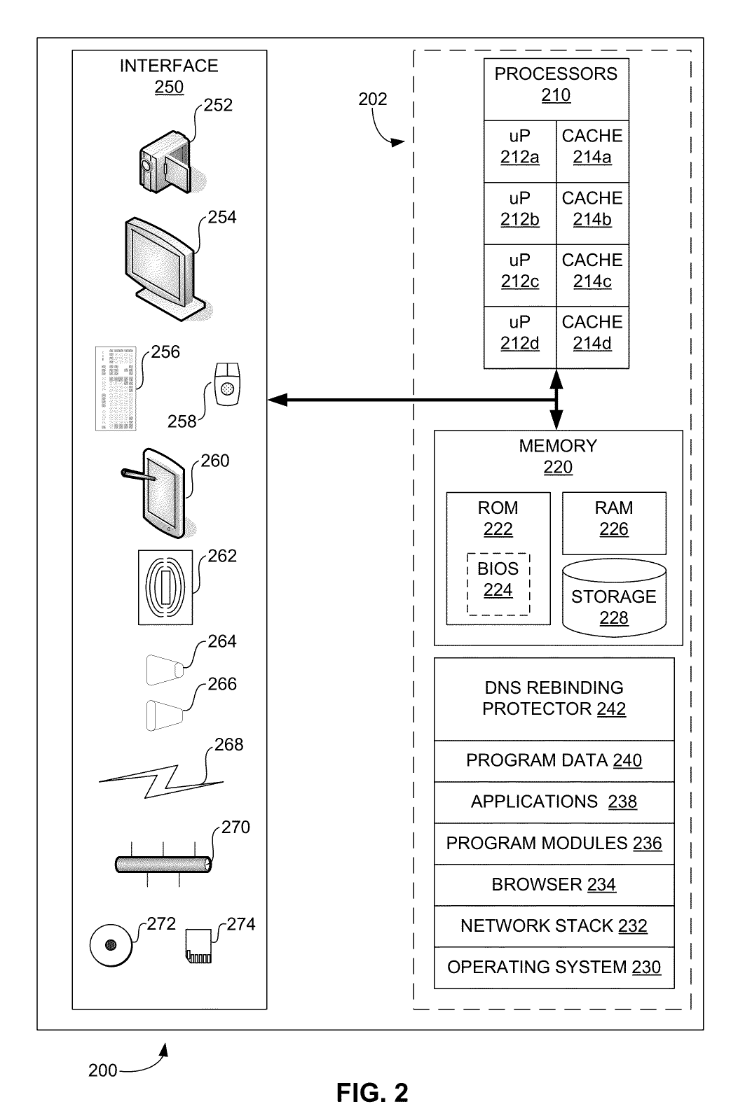

FIG. 1 is a network diagram illustrating a network that is suitable for practicing aspects of dynamic name system rebinding attack protection in accordance with exemplary embodiments of the disclosure. Network system 100 includes consumer 120, 130, and 140 (machines, for example), service provider 150, third party resource provider 160, cellular communications provider 170, and data storage provider 180. Consumers 120, 130, and 140 access and communicate with network 110 using communication links 122, 132, and 142 respectively. Each of the consumers 120, 130, and 140 can be (or internally provide functions of) the (illustrative) computing device 200 discussed below with reference to FIG. 2.

Network 110 typically includes a publically accessible network such as the Internet, but other networks (including private networks) can be used. Thus, network 110 is typically a collection of networks (and gateways) that typically use a TCP/IP suite of protocols for packet-based communications. The Internet typically employs high-speed data communication lines between major nodes or host computers, but even bandwidth between the major nodes is subject to degradation through satellite outages, hardware faults, denial of service attacks, oversubscription of services, and the like. The network connections are shown for the purpose of illustration, and other ways of establishing a communications link between computers (such as using firewalls, as discussed below) can be used.

Consumers 120, 130, and 140 access the network 110 to access networked service providers of services such as service provider 150, third party resource provider 160, cellular communications provider 170, and data storage provider 180. Service provider 150 accesses network 110 via communication link 152, whereas third party resource provider 160 accesses network 110 via communication link 162. Cellular communications provider 170 accesses network 110 via communication link 172 and provides, for example, further connectivity to cellular devices 176 via a cellular network 174. Data storage provider 180 accesses network 110 via communication link 182 to provide, for example, secure backup systems for consumer 120 data. The actual data processing systems of network system 100 may include additional servers, clients, peers, and other devices not illustrated. Each of the service provider 150, third party resource provider 160, cellular communications provider 170, cellular devices 176, and data storage provider 180 can be (or internally provide functions of) the (illustrative) computing device 200 discussed below with reference to FIG. 2.

FIG. 2 shows an illustrative computing device 200 in accordance with exemplary embodiments of the disclosure. For example, the computing device 200 includes a processing system 202 that is arranged to perform specific tasks in response to applications 238 and program data 240. Processing system 202 is often incorporated into a computing device such as a mobile device, a personal digital assistant, a personal computer, a dedicated web-enabled appliance, a kiosk terminal, automotive electronics, or any other type of networked electronic system or subsystem.

The processing system 202 includes processors 210 and memory 220. Processors 210 may include one or more microprocessor (uP) cores 212a, 212b, 212c, and 212d, each of which is optionally coupled to a respective, local cache 214a, 214b, 214c, and 214d. Memory 220 includes a ROM (read-only memory) 222, RAM (random-access memory) 226, and storage 228 (such as a “hard” disk). ROM 222 optionally includes BIOS (basic input/output system) 224, which typically includes low-level firmware-based drivers for accessing, for example, low-level, hardware-based elements of computing device 200.

Memory 220 includes instructions and data for executing (software) applications 238 (for example), that when executed by processing system 202, perform any suitable function associated with the computing device 200. For example, the processing system 202 executes software (including firmware) and data components such as operating system 230, network stack 232, browser 234, program modules 236, applications 238, program data 240, and DNS rebinding protector 242.

Processing system 202 is accessible to users and non-local components using interface 250. Interface 250 provides a user interface that is typically arranged to provide output to and receive input from the user during the execution of the software applications 238. The output to the user is provided by devices such as the display 254 (including indicator lights and image projectors), a speaker 264, vibrations 262, and the like. The input from the user is received using keyboard 256, mouse (and/or trackball) 258, touch/stylus screen 260, audio input 266 and/or video input 252. Other devices can be used such as keypads, switches, proximity detectors, and the like.

The interface 250 is also arranged to transmit communications to and from other computers across a network. Wireless link 268 permits communications using a modulated optical and/or electromagnetic carrier (such as cellular telephone communications). Cabled link 270 permits communications over a wired and/or optical link (such as optical Ethernet and/or Ethernet). The wireless link 268 and cabled link 270 are optionally employed between other network-enabled devices to establish wide-area networks, local-area networks, private networks, and the like. Additionally, tangible media such as disk 272 or “flash” ROM 274 (and the like) are used to store data and instructions and are read from and/or written to by interface 250 in the course of execution of the DNS rebinding protector 242, for example.

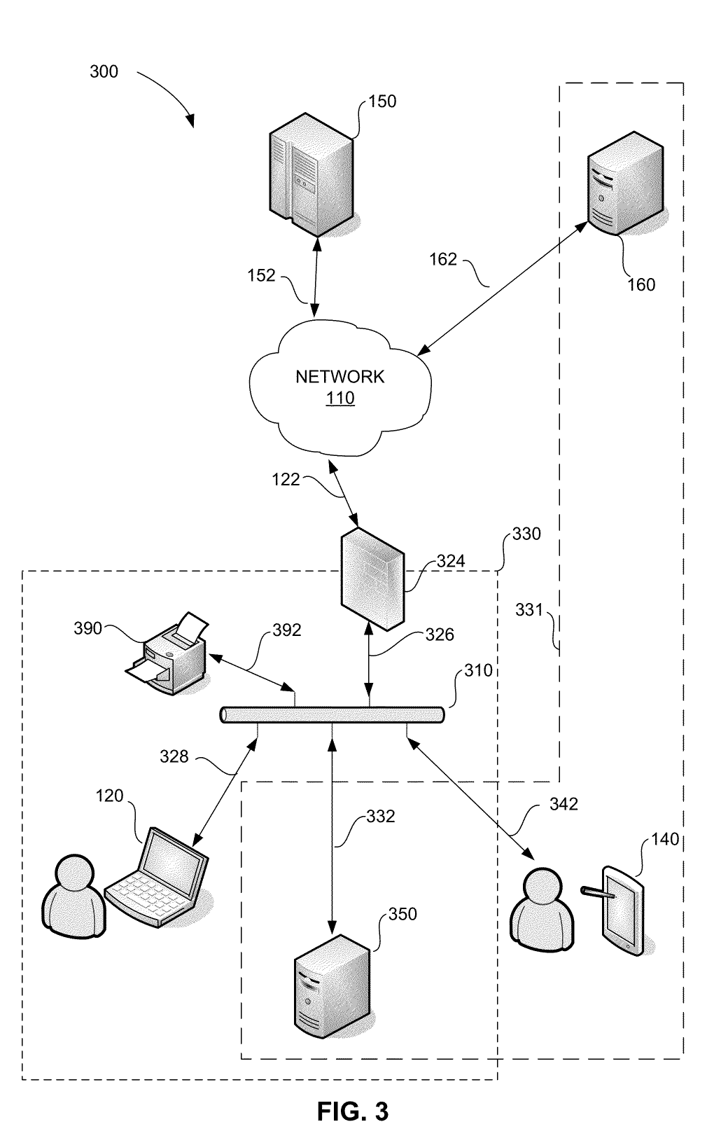

FIG. 3 is a network diagram illustrating in conjunction with FIG. 2 a network that includes domain name system rebinding attack protection in accordance with exemplary embodiments of the disclosure. Network system 300 includes service provider 150 and third party resource provider 160, as discussed above. Service provider 150 is arranged to provide networked content (such as services, data and/or applications, and the like) to consumer 120 via network 110. The content and services are generally provided in the form of communications such as webpages, where the webpages (and other communications) often contain references (e.g., “links”) to “external” resources that are to be provided by the third party resource provider 160 (which is also a networked services provider). The content and services can include banking, information storage, search engines and can be networked via the Internet or private (such as a virtual private network).

Service provider 150 is a server (or a set of servers that are presented as a single server or a “virtual” server for processing requests). The consumers 120 and 140 are typically clients with respect to the server (e.g., service provider 150 and server 350). The consumer 120 and server 350 are networked resources such as, for example, computers that are networked together in a trusted zone 330. A second trusted zone 331 can be arranged having, for example, consumer 140, server 350, and third party service provider 160 in the trusted zone, but excluding consumer 120 from the trusted zone.

A trusted zone is an exemplary group of network resources (e.g., “machines”) that have trusted communications amongst the network resources of a particular trusted zone (such as trusted zone 330) associated with the network-enabled application. The network resources inside the first trusted zone have untrusted communications between a network resource of the first trusted zone and a network resource outside of the first selected trusted zone. For example, communications amongst network resources of the first selected trusted zone can be considered to be “trusted,” and communications between a network resource of the first selected trusted zone and a network resource outside of the first selected trusted zone can be considered to be “untrusted.” Thus, exploits (if any) on a machine of a second selected trusted zone (such as consumer 140 of trusted zone 331, wherein the machine is not also included in trusted zone 330) do not have a level of “trusted” access to all machines included in the first selected trusted zone (such as consumer 120 in trusted zone 330).

Trusted zones 330 and 331 are protected against attacks from networked resources (such as third party resource provider 160) by firewall 324, which processes communications from the consumers 120 and 140 across the network 110 by providing network address or port address translation, and/or by providing proxy services. Network 310 provides a link 326 for communicating with the firewall 324, a link 328 for communicating with consumer 120, a link 332 for communicating with server 350, a link 342 for communicating with consumer 140, and a link 392 for communicating with printer 390. For example, the consumers 120 and 140 are arranged as local network resources that are networked together in separate trusted zones using a firewall 324 and/or authentication such that the network resources are otherwise inaccessible to an external attack. A trusted zone can include network resources from within a private address space (that includes consumers 120 and 140, for example) as well as network resources that lie outside of the private address space. Thus, the trusted zone can include network resources from a virtual private network where network resources are securely accessed over a public or private network.

The DNS rebinding protector 242 is arranged to (for example) determine whether a lexical element received in a communication from a service provider outside of a first zone is arranged to attempt to rebind an address association of a selected domain name from a binding of an address in first zone to a binding of an address that lies in a zone that is different from the first zone.

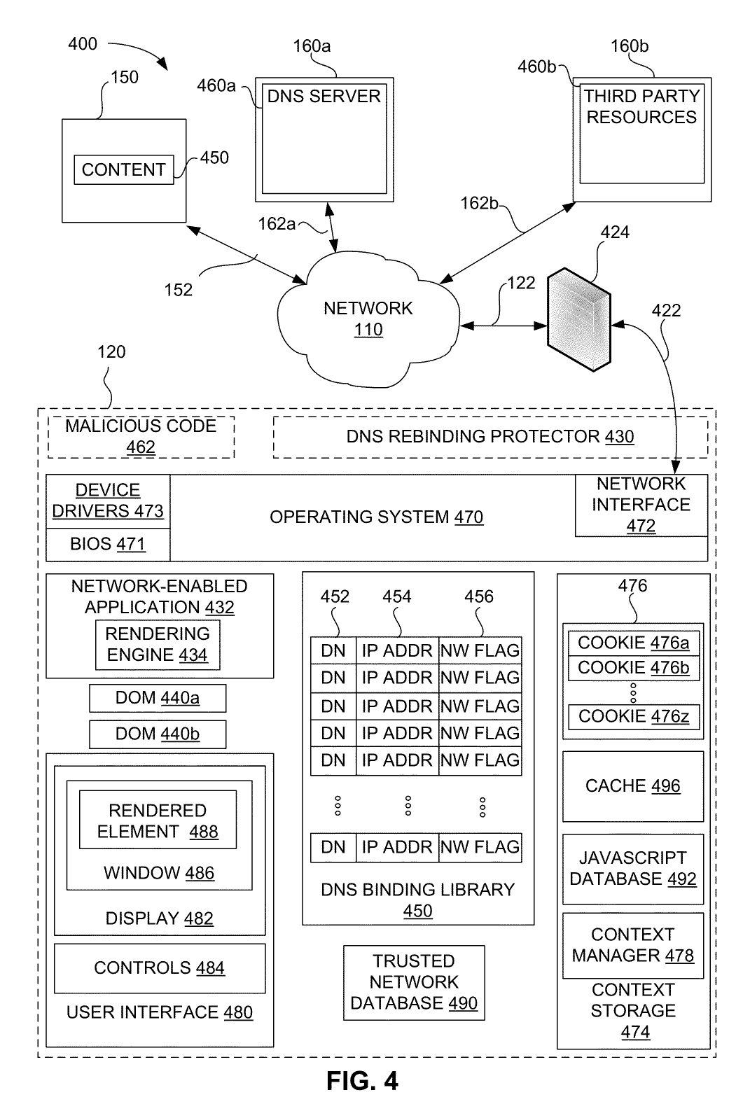

As further described below (e.g., with reference to FIG. 4), the determination can be a) made before a document object model (DOM) containing the element is rendered, b) made during the rendering (including updating) of the DOM, and c) made in response a request being initiated to attempt to rebind the address of the selected domain name to a different zone. Accordingly, the DNS rebinding protector 242 can, for example, detect when an attacker's payload attempts to use a loaded element (on a browser running on a victim consumer 120 machine, for example) to access another network resource that trusts the victim consumer machine. Thus, an attack that is arranged to address a network resource that lies inside the trusted zone 330 is detected so that appropriate protective actions can be taken (for example) before any potential harm from the attack can occur.

The DNS rebinding protector 242 is variously arranged to initiate taking a protective action such as sending warning signals and/or blocking the attempts by the malicious rendered element (such as rendered element 488, discussed below) another network resource that lies within the trusted zone 330. The warning signal can be a warning signal that is used for internal (triggering) purposes and/or for purposes of conveying a warning to a related entity such as networked service provider (e.g. 160), user, administrator, security event logger, and the like (and combinations thereof) that conveys the existence (and optionally attributes) of the malicious element. The concerned entity can include a networked service provider (e.g., 150) of the content that includes the rendered element (e.g., 488), a user of the networked-enabled application (e.g., 432, discussed below) that retrieved the rendered element, an administrator of the computer (and/or network) on which the network-application is executing. The attempts by the rendered element to address a network of another network resource (e.g., 350) that lies within the same private local area network can be selectively blocked by blocking (including logging, denying, delaying, and the like) the attempts in response to a command by a user, an administrator, a third-party security services provider, and the like that are warned of the malicious element by the warning signal.

FIG. 4 is a logic diagram illustrating a network resource having a domain name service rebinding protector 430 in accordance with exemplary embodiments of the disclosure. Network system 400 includes, for example: consumer 120, service provider 150, and third party resource providers 160a and 160b. Consumer 120 is arranged to communicate (e.g., securely) with network 110 using communication links 122, firewall 424, and communication link 422. Third party resource providers 160a and 160b are arranged to communicate with network 110 using communication links 162a and 162b respectively.

Consumer 120 typically includes a network-enabled application 432 that is arranged to conduct communications between service provider 150 and consumer 120. For example, network-enabled application 432 includes a browser such as Chrome, Firefox, Internet Explorer, and the like. A user performs an action such as following a bookmark, or clicking on a local link, opening a Word or PDF document, entering a URL (universal resource locator) or IP (Internet protocol) address, or selecting a displayed control to select content 450 (or a portion thereof) hosted by service provider 150, and the like. The selection is relayed by the browser via the network 110 to the addressed service provider (e.g., service provider 150) having the selected content. When an address using a domain name is provided in the communication, a DNS server (e.g., DNS server 460a) is used, for example, to provide an IP address that is used to send the request to service provider 150.

Service provider 150 responds by sending a communication to the consumer 120. The communication is received by the network interface 472 of operating system 470 and the communication is passed to the network-enabled application 432 for decoding and rendering, for example, using a window 486 in the display 482.

The communication is often a webpage written in a markup language, although other formats can be used such as style sheets, JavaScript reference, and the like. The webpage often contains elements that address content provided by the service provider 150 as well as content provided by one or more third party resource providers 160 (such as third party resource providers 160a or 160b). The references in the received communication are, for example, instantiated using a DOM (document object model) 440 as the network-enabled application 432 parses the received communication in accordance with the format used to encode the information encoded in the received communication. The DOM 440 can be arranged as a parent DOM that is associated with one or more children DOMs, wherein each of the DOMs can be associated with a network resource that is determined by the received communication.

As the network-enabled application 432 parses the received communication, the network-enabled application 432 constructs a DOM 440 (such as DOMs 440a and 440b) that delineates the structure and the function of the encoded information. The DOM 440 is arranged to render both content of requested third party resources (such as third party resources 460b) and local references on the same website, for example. The rendered content can be used to manage a window 486 of a webpage (conveyed by the encoded information) for display in the display 482 (typically via BIOS 471 of the operating system 470). The display 482 is used to provide visual indications to a user and to prompt (e.g., query) the user for input. The user input is captured using controls 484 (such as by a keyboard and/or a mouse) of the user interface 480.

Window 486 is a (e.g., computer program) application window that is arranged to display program output and to help capture user input. Window 486 is, for example, a window of a network-enabled application 432 and is associated with a rendered element 488 that is arranged to be selected by a user using controls 484. The rendered element 488 is included in the received communication by the service provider 150 as a, for example, malicious element that is rendered by rendering engine 434 in accordance with DOM 440a, for example. The malicious element can contain exploits that target (or attempt to target) vulnerabilities in the domain name system (DNS) bindings. As discussed further below, the DNS binding library 450 can be a single or distributed library, having records to, for example, determine whether a DNS binding is associated with a trusted zone (such as an RFC1918-like private network).

In a typical DNS rebinding attack, an attacker attempts to firstly target a device (such as consumer 120) in the private network (e.g., 130) that has access to the Internet (e.g., 110) by enticing a user of the device to navigate to a malicious site 460b (that the attacker controls). The attacker also uses a DNS server 460a (that the attacker also controls) to provide a first IP address in response to a first DNS request from the firstly targeted device (e.g. 120). The IP address response is assigned a relatively short time-to-live (TTL) value. When the firstly targeted device 120 tries to use the first IP address to access the malicious site 460b, the malicious site 460b returns a first response that contains malicious code 462 such as JavaScript code. The malicious code 462, for example, can be a request such as the “XMLHTTPRequest” (extensible markup language hypertext transfer protocol) request that “scrapes” the page and requests that information be returned to a designated network address. The malicious code 462 is arranged to be triggered by a (e.g.) JavaScript timer that is programmed to trigger after the TTL expires. Before the timer expires (and the second malicious request discussed below is triggered), the malicious site 460b (and/or network) will typically block subsequent accesses to the malicious site 460b. The subsequent accesses are blocked for the purpose of forcing a browser of the firstly targeted device 120 to request another DNS response (which the browser generates as an attempt to handle the likelihood that the blocked website is “down”).

When the timer expires, the malicious code 462 is arranged to send a return communication to the first provided IP address. The malicious site 460b (and/or network) blocks the access, which causes (in accordance with the TTL being expired) the firstly targeted device 120 to perform a second DNS request using the same domain name as used in the first DNS request (regardless of “DNS pinning,” if any). A second IP address that is different than the first provided IP address is provided in the second IP address response, where the second IP address can be (for example) an address of a (relatively) non-externally accessible device (e.g., 530) within the private network of the firstly targeted device. The firstly targeted device 120 uses the second IP address (in combination with a second malicious request, for example) to send a command to the (relatively) non-externally accessible device 530 in accordance with the particular intent of the attacker. The intent of the attacker can include malicious activity such as transferring funds from a bank account, changing the value of entries in a database, discovery of confidential information, reading security one-time tokens (nonces), and the like.

The DNS binding library 450 includes records having a domain name (DN) field 452, an internet protocol address (IP ADDR) field 254, and a network flags field (NW FLAG) 456. Accordingly, each record is arranged to store information concerning a domain name (in DN field 452), the IP address retrieved from a DNS server in response to a query containing the domain name (in IP ADDR field 454), and network status information (in NW flags field 456). The network status information, for example, denotes whether a DNS binding (as shown by the DN field 452 and IP ADDR field 454 of each record), is associated with a network service provider that is inside of a trusted zone.

To reduce the possibility of successfully exploiting vulnerabilities of domain name system bindings, the DNS rebinding protector 430 (which is a DNS rebinding protector such as DNS rebinding protector 242) is arranged, for example, to determine whether an existing DNS binding is rebound from an IP address associated with a network resource outside of a trusted zone to an IP address that is associated with a network resource inside of a trusted zone. The DNS rebinding protector 430 typically works in conjunction with the trusted network database 490 and may have functional components that are distributed amongst and/or shared with components of the trusted network database 490. (A trusted network may include one or more trusted zones.)

In operation, the DNS rebinding protector 430 is arranged, for example, to determine whether a domain name binding for a selected domain name that is associated with an IP address in a non-trusted zone is changed in response to a subsequent DNS request using the selected domain name to an IP address in a trusted zone. When a network-enabled application such as Internet Explorer is used to browse a web page addressed by the selected domain name, the DNS rebinding protector 430 is arranged to detect a switch from a non-trusted zone (such as the Internet) to a (e.g., local) RFC-1918 zone.

When the switch from a DNS binding from an untrusted zone is made to a DNS binding to a trusted zone (for a selected domain name), the DNS rebinding protector is arranged to take a protective action to reduce the risk of a successful DNS rebinding attack. For example, the DNS rebinding protector 430 can produce a warning signal (as discussed above) to notify concerned parties as well as to remove or (at least) partially remove a context established by the element responsible for selecting the domain name associated with the switch from a DNS binding from an untrusted zone to a DNS binding to a trusted zone.

In response to the detection of the switch from a DNS binding from an untrusted zone to a DNS binding to a trusted zone, the DNS rebinding protector 430 is arranged to notify context manager 478 to remove (or remove a portion of) the context associated with the responsible element (such as malicious code 462, which is malicious at least by virtue of containing the domain name responsible for the DNS rebinding attack). The context (or a portion of the context) is removed such that the DNS rebinding attack is broken and/or rendered harmless.

For example, the context manager 478 consults the DOM (such as DOM 440a) associated with the responsible element and identifies items in the context storage 474 that are involved in the DNS rebinding attack. The context storage 474 is illustrated as including a JavaScript database 492, cache 496, and cookies 476 (although other context information can be included). Thus, the context manager 478 removes or “flushes” (or removes portions of) state information stored by a browser such as the JavaScript database 492, cache 496, and cookies 476 and one or more of cookies (such as cookies 476a, 476b, through 476z) wherein each deleted context element is associated with the responsible element or would otherwise be required for the DNS rebinding attack to succeed. Accordingly, the DNS rebinding protector 430 is arranged to “break” any request that attempts to use a malicious DNS rebinding so that the request cannot be sent to another network resource in a trusted zone.

Network-enabled applications 432 (such as browser engines, messaging interfaces, e-mail tools, remote desktops, and the like) can access functions of the DNS rebinding protector 430 by adding to and/or replacing functionality often provided by the operating system 470. The network-enabled applications 432 can operate (at least to a degree) independently of the operating system 470 (such as by notifying the DNS rebinding protector 430 of each DNS request). Accordingly, a browser application can operate in conjunction with (and/or incorporate features of) the DNS rebinding protector 430. Further, each executing browser application can be associated with its own instance of a DNS rebinding protector 430 (e.g., such that multiple DNS rebinding protectors 430 are instantiated).

For example, the DNS rebinding protector 430 can display a notification signal in the window 486 itself, or as a URL (universal resource link) signal, a DNS (domain name server) signal, or an HTTP (hypertext transfer protocol) header, or HTML (hypertext markup language) tag. Also, a modal dialog (that is similar to, e.g., an alert dialog) that pops up (or is otherwise brought into view) above the window itself can be used to display the notification signal and related forensic attributes as discussed above. Audible notifications signals can also be generated.

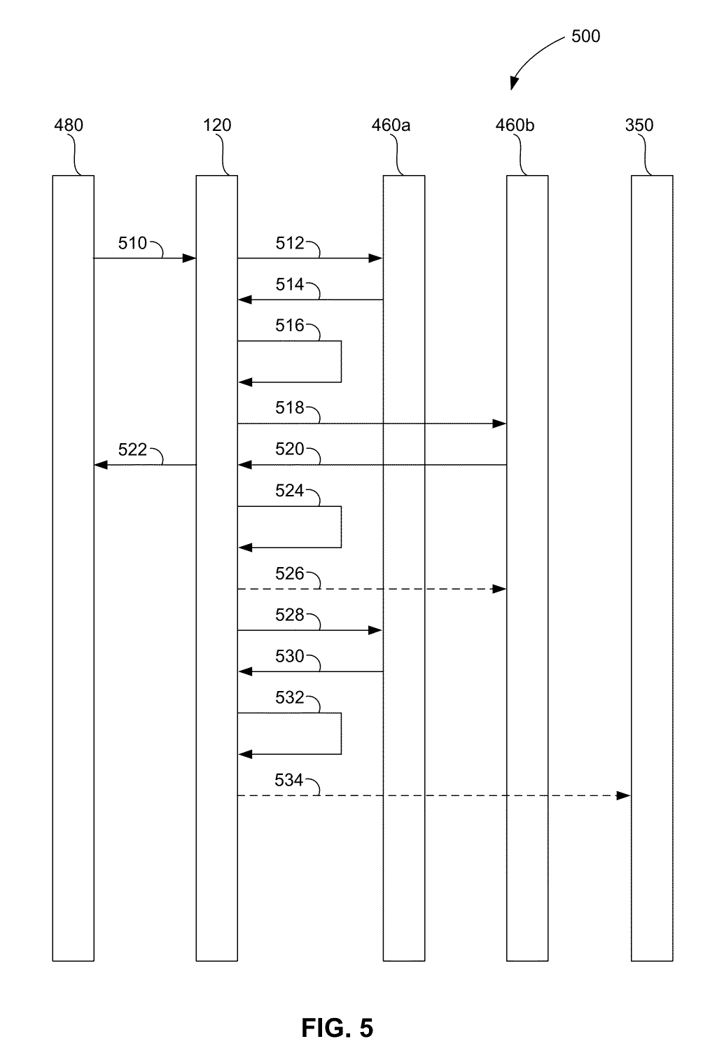

FIG. 5 is a signaling diagram illustrating in conjunction with FIG. 4 operation of a domain name service rebinding protection architecture in accordance with exemplary embodiments of the disclosure. Signaling diagram 500 illustrates communications transmitted and received between and amongst the user interface 480, for example, consumer 120, DNS server 460a, (e.g., malicious) third party resources 460b, and (trusted network) server 350. A user at user interface 480 sends a command 510 to consumer 120 to (eventually) generate a request 518 for content (or other services) from third party resources 460b. In response to command 510, consumer 120 sends a request 512 containing a selected domain name (that is associated with third party resources 460b) to DNS server 460a. In response to the request 512, the DNS server 460a returns to consumer 120 a communication 514 that includes an associated IP address that is associated with third party resources 460b. The associated IP address response is assigned by the DNS server 460a a relatively short time-to-live (TTL) value (which, for example, is set to expire after request 518 would be generated, but before request 526 would be generated—as discussed below).

In response to communication 514, the DNS rebinding protector 430 generates a signal 516 to determine whether the selected domain name sent in communication 512 or the IP address returned in communication 514 is already stored in the DNS binding library. If the selected domain name sent in communication 512 or the associated IP address returned in communication 514 is not already stored in the DNS binding library, the selected domain name and the associated IP address are stored in the DNS binding library and a query is issued to trusted network database 490 to determine whether, for example, the associated IP address is associated with a network resource that lies inside of a trusted network in which consumer 120 is arranged. The result of the trusted network determination is stored in network flags 456. (If consumer 120 is arranged in multiple trusted zones, network flags 456 can store an indication of the trusted zone in which the addressed network resource—identified by the associated IP address—is arranged.)

Consumer 120 generates the request 518 to the third party resource 460b using the associated IP address supplied in communication 514 in response to the DNS server request 512 (assuming a change in trusted zones for a previously existing domain name-IP address binding has not been detected, as discussed below). In response to the request 518, the third party resource 460b generates a communication 520 that returns malicious code such as JavaScript code.

When the communication 520 is received and parsed (for example), consumer 120 constructs (for example) a DOM 440 that determines the structure and function of window 486. The DOM 440 is rendered and the results are sent via communication 522 to user interface 480 for display in window 486. Window 486 includes a rendered element 488 that is included in the malicious code. The malicious code is arranged to be triggered by a (e.g.) JavaScript timer that is programmed to trigger (to generate signal 524, for example) after the TTL timer expires (discussed above with respect to communication 514).

Before the malicious code timer expires (and request 526 is thereby triggered), the malicious site (and/or network) will typically block subsequent accesses to the malicious site. Thus, when request 526 is triggered (by signal 524, for example), the (attempted) request 526 is blocked (by the malicious third party resource 460b, for example) for the purpose of forcing the consumer 120 browser to request another DNS response (which the browser typically generates as an attempt to handle the likelihood that the blocked website is “down”).

Accordingly, when consumer 120 does not receive a reply in response to the (blocked) request 526, (in accordance with the TTL being expired) consumer 120 generates a (DNS) request 528 containing the selected domain name (that is associated with third party resources 460b) to DNS server 460a (regardless of “DNS pinning,” if any). In response to the request 528, DNS server 460a returns to consumer 120 a communication 530 that includes a second associated IP address that (instead of being associated with third party resources 460b) is associated with the IP address of a targeted machine (e.g., server 350) that is arranged in a trusted zone.

In response to communication 530, the DNS rebinding protector 430 generates a signal 532 to determine whether the selected domain name of request 528 is the same as the selected domain (and/or domain name) that has been used with a previous DNS request 512 (for which a response has been received).

In another exemplary embodiment, the rebinding protector 430 generates a signal 532 to determine whether the selected domain name and the second associated IP address (associated with server 350) are different from the domain name and IP address pair stored in the DNS binding library. Because the domain name and the new IP address pair is different from the domain name and the previous IP address (associated with third party resource 460b) already stored in the DNS binding library, a query is issued to trusted network database 490 to determine whether, for example, the IP address is associated with a network resource that lies inside of a trusted network in which consumer 120 is arranged. The result of the trusted network determination can be stored in network flags 456.

If a change in the network flags (for example) indicates a change in the IP address from a first zone to a second zone (such as from a non-trusted zone to a trusted zone, from a first trusted zone to a second trusted zone, from a trusted zone to a non-trusted zone, and the like), signal 534 also generates a warning signal that initiates taking a protective action such as sending notification signals and/or blocking the attempts by the rendered element to address another network resource that lies within the trusted zone.

The attempts by the rendered element to address a network of another network resource that lies within the trusted zone can be blocked by removing a context that is relied upon by the rendered element to successfully address the network resource that lies within the trusted zone. For example, the context manager 478 consults the DOM associated with the responsible element and identifies items in the context storage 474 that are involved in the DNS rebinding attack. All (or some of) the identified items (including a JavaScript database 492, cache 496, and cookies 476 and other such context information) are flushed such that the DNS rebinding attack is broken and/or rendered harmless.

The attempts by the rendered element (such as by request 534) to address a network of another network resource that lies within the same private local area network can be selectively blocked by blocking (including logging, denying, delaying, and the like) the attempts in response to a command by a user, an administrator, a third-party security services provider, and the like that are warned of the malicious element by the warning signal.

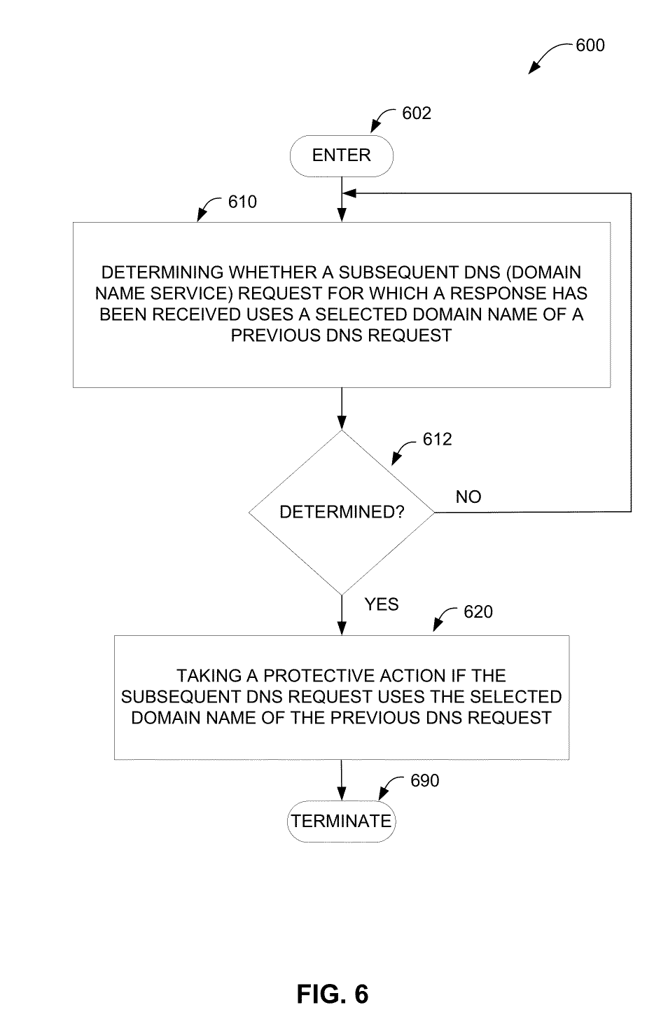

FIG. 6 is a flow diagram illustrating domain name service rebinding protection architecture in accordance with exemplary embodiments of the disclosure. The program flow illustrated herein is exemplary, and thus various operations (and various portions of the operations) within the program flow can be performed concurrently and/or in an order that is not necessarily the same as the program flow illustrated herein (including, for example, using logical substitutions and reordering made in accordance with DeMorgan's theorems and Boolean algebra). Program flow 600 begins at node 602 and proceeds to operation 610.

In operation 610, it is determined whether a subsequent DNS (domain name service) request for which a response has been received uses a selected domain name of a previous DNS request. For example, the determination can be used to preempt an attempt to rebind a DNS binding from an IP address that addresses a network resource outside of a trusted zone to an IP address that addresses a network resource in the trusted zone. Program flow proceeds to operation 612

In operation 612, the result of the DNS request determination is evaluated. If the determination is made that the subsequent DNS (domain name service) request for which a response has been received uses a selected domain name of a previous DNS request, program flow proceeds to operation 620. If the determination is not made that the subsequent DNS (domain name service) request for which a response has been received uses a selected domain name of a previous DNS request, program flow proceeds to operation 610, where another domain name response is used for another determination.

In operation 620 a protective action is taken if the subsequent DNS request uses the selected domain name of the previous DNS request. For example, the protective action can include removing a context (which includes the meaning of “deletion of a portion that is less than the entire portion of the context”) that would otherwise be required for the DNS rebinding attack to succeed.

The various exemplary embodiments described above are provided by way of illustration only and should not be construed to limit the claims attached hereto. Those skilled in the art will readily recognize various modifications and changes that could be made without following the example exemplary embodiments and applications illustrated and described herein, and without departing from the true spirit and scope of the following claims.

1. A method, comprising:
determining, in response to receiving in a client a response to a subsequent DNS request, whether the subsequent DNS (domain name service) request uses a selected domain name of a previous DNS request; and
taking a protective action if the subsequent DNS request uses the selected domain name of the previous DNS request, wherein the protective action includes selectively blocking the subsequent DNS request.

2. The method of claim 1, comprising determining whether a second address received in response to the subsequent DNS request is different from a first address received in response to the previous DNS request.

3. The method of claim 2, wherein the protective action is taken in response to a determination that the second address received in response to the subsequent DNS request is different from the first address received in response to the previous DNS request.

4. The method of claim 2, comprising determining whether a second zone associated with the second address received in response to the subsequent DNS request for the selected domain name is different from a first zone associated with the first address received in response to the previous DNS request for the selected domain name.

5. The method of claim 4, wherein the protective action is taken in response to the determination that the second zone associated with the second address received in response to the subsequent DNS request for the selected domain name is different from the first zone associated with the first address received in response to the previous DNS request for the selected domain name.

6. The method of claim 4, comprising determining whether the second zone is a trusted zone that includes an address from which the subsequent and previous DNS requests are sent.

7. The method of claim 6, comprising determining whether the first zone is not a trusted zone that includes the address from which the subsequent and previous DNS requests are sent.

8. The method of claim 6, wherein the protective action is taken in response to the determination that the second zone is the trusted zone that includes the address from which the subsequent and previous DNS requests are sent.

9. The method of claim 6, comprising storing information concerning a received address for each domain name of each DNS request.

10. The method claim 9, comprising storing zone information for the received address of each DNS request.

11. The method of claim 2, wherein the protected action includes prohibiting an access to the second address.

12. The method of claim 11, wherein access to the second address is prohibited by removing a context established a lexical element responsible for selecting the domain name.

13. The method of claim 12, wherein the context is removed by deleting cookies associated with the lexical element.

14. The method of claim 12, wherein the context is removed by flushing a cache that is associated with the lexical element.

15. The method of claim 12, wherein the context is removed by flushing state information stored by a browser from which the subsequent and previous DNS requests are sent.

16. A tangible non-transitory medium including instructions that, when executed on a processor of an electronic system, comprise:
determining, in response to receiving in a client a response to a subsequent DNS request, whether the subsequent DNS (domain name service) request for which a response has been received uses a selected domain name of a previous DNS request; and
taking a protective action if the subsequent DNS request uses the selected domain name of the previous DNS request.

17. The medium of claim 16, comprising determining whether a second address received in response to the subsequent DNS request is different from a first address received in response to the previous DNS request.

18. The medium of claim 17, comprising determining whether a second zone associated with the second address received in response to the subsequent DNS request for the selected domain name is different from a first zone associated with the first address received in response to the previous DNS request for the selected domain name.

19. The medium of claim 18, comprising determining whether the second zone is a trusted zone that includes an address from which the subsequent and previous DNS requests are sent.

20. The medium of claim 19, comprising determining whether the first zone is not a trusted zone that includes the address from which the subsequent and previous DNS requests are sent.

21. A web browsing system, comprising:
a network-enabled client machine that is configured to generate DNS (domain name service) requests using a selected domain name for each DNS request;
a DNS binding library that is arranged to store a domain name received for each response received for a DNS request; and
a DNS rebinding protector that is arranged to take a protective action in response to receiving a response to a subsequent DNS request and in response to a determination that a subsequent DNS request uses the selected domain name of a previous DNS request stored in the DNS binding library.

22. The system of claim 21, wherein the determination that a subsequent DNS request uses the selected domain name of a previous DNS request is made after a response is received by the network-enabled machine to the subsequent DNS request.

23. The system of claim 22, wherein the DNS rebinding protector is arranged to store an address received for each response received for a DNS request.

24. The system of claim 23, wherein the determination that a subsequent DNS request uses the selected domain name of a previous DNS request is made includes determining whether a second address received in response to the subsequent DNS request is different from a first address received in response to the previous DNS request.

25. The system of claim 24, wherein the DNS rebinding protector is arranged to store network information that includes whether the address received for each response received for a DNS request is located within a trusted zone.

26. The system of claim 25, wherein the determination that a subsequent DNS request uses the selected domain name of a previous DNS request is made includes determining whether a second zone associated with the second address received in response to the subsequent DNS request for the selected domain name is different from a first zone associated with the first address received in response to the previous DNS request for the selected domain name.

27. The system of claim 26, wherein the network-enabled machine has an address that is associated with the trusted zone.

28. The system of claim 27, comprising a context manager that is arranged to remove a context established by a lexical element responsible for selecting the domain name.

29. The system of claim 28, wherein the removed context includes state information that is necessary to generate a request to a resource having the second address.

30. The system of claim 29, comprising a trusted network database that is arranged to provide information whether an address associated with a DNS request is located within the trusted zone.
